(19) United States
(12) Patent Application Publication
(10) Pub. No.: US 2025/0037599 A1
(43) Pub. Date: Jan. 30, 2025

(54) SYSTEM AND METHOD FOR ACTIVE ASSESSMENT OF A USER PROFILE BASED ON TRAINING MATERIAL

(71) Applicants: Alemira AG, Schaffhausen (CH); Constructor Education and Research Genossenschaft, Schaffhausen (CH)

(72) Inventors: Daniil Lazutkin, Sofia (BG); Laurent Dedenis, Singapore (SG); Serg Bell, Costa del Sol (SG); Stanislav Protasov, Singapore (SG)

(21) Appl. No.: 18/357,636

(22) Filed: Jul. 24, 2023

(51) Int. Cl. G09B 7/077; G06F 40/205

(52) U.S. Cl. CPC G09B 7/077; G06F 40/205; G06F 40/30

(57) ABSTRACT

Systems and methods for conducting an active assessment of students based on the training material uploaded by a lecturer. A training database obtains the training material which is classified based on a content type by the data classifier. According to the content type, a content to text constructor applies different techniques to convert the content into text. The text is analyzed by the text analyzer. The text analyzer includes a semantic analyzer to perform semantic analysis on the text, a question generator to generate a set of questions based on the semantic analysis and select most relevant questions from the set, and an answer generator module to generate at least one correct answer and multiple incorrect answers for each question. The test script is generated including the questions and answers. Based on the selection of the answer, an assessment of the student is performed.

### TECHNICAL FIELD

The present disclosure generally relates to an educational testing system. In particular, the present disclosure relates to active assessment of a user in educational testing.

### BACKGROUND

The education system evolved to a great extent in the last few decades. However, the basis of the education system has remained same; in particular, a lecturer delivers a lecture and/or provides training material to a class of students, prepares a question paper based on the taught subject matter for students to answer the questions, and finally, based on the answers provided by each question, assesses the student and allots a grade. Conducting the entire examination process manually has restricted the education system to very few examinations throughout the academic year.

With the move to and evolution of e-learning systems or online educational platforms, the process of learning has become more effective and convenient. For example, conducting frequent exams or asking questions regularly to the students about the subject matter which they have recently learned, makes the learning process much faster and more efficient compared to infrequent examinations. E-learning systems allow the lecturer to formulate questions, circulate the questions among the students and receive the answers to the questions through a network. However, the lecturer may face challenges of not repeating the questions, maintaining the quality and difficulty level of the questions, and many other factors that may limit the flexibility of the lecturer to assess the students.

Therefore, there is a need for improved user assessment through automatic generation of questions based on the training material of the taught subject matter.

### SUMMARY

The present disclosure relates to a system and method for conducting active assessment of a user based on training material. In some embodiments, the method includes obtaining the training material from one or more training sources, classifying the training material into at least one pre-defined category based on a content type, and applying at least one content-to-text construction technique, based on the pre-defined category of the content type, to convert the training material into text. The method further includes parsing the text for generating a test script including by performing semantic analysis of the text to determine semantics and meaning of phrases of the text; generating a first set of questions based on the semantic analysis of the text; generating a second set of questions based on the first set of questions; selecting a third set of questions from the second set of questions considered most relevant based on a topic of training and a specific lesson related to the topic, and generating a test script including correct answers to the third set of questions and incorrect answers to the third set of questions based on semantic analysis of the text. The method further comprises presenting the test script to a user.

In some embodiments the predefined category of the content type includes at least one of a presentation, a recorded video, a recorded screen, a document or a chat log.

In some embodiments, applying at least one content-to-text construction technique comprises applying an audio-to-text generator, applying a text data parser, or applying an image to text generator.

In some embodiments, the questions are selected based on predefined criteria, and relevance of the questions to the topic is determined based upon a predefined set of rules.

In some embodiments, the one or more training sources comprises a video recording of a lecture, a presentation file containing graphics and text data, a document, a code sample, a chat log, material stored during a lecture session, a PDF file, and a webpage.

In some embodiments, presenting the test script to the user comprises presenting a set of one correct answer and one or more incorrect answers for the user to select at least one answer from the set of one correct answer and the one or more incorrect answers.

In some embodiments, the method is implemented through a web server, a container, a virtual machine, a plugin, or a preinstalled software.

In some embodiments, the test script is displayed on a display screen operated by the user.

In some embodiments, a first student user and a second student user are associated with a lecture session and the system operations of claim 10 are repeated for the first student user and the second student user. A first test script associated with the first student user includes a unique set of questions different than a second test script associated with the second student user.

The present disclosure further relates to a system to conduct active assessment of a user based on training material. In some embodiments, the system comprises a training database to store the training material from one or more training sources, a data classifier configured to classify the training material into at least one pre-defined category based on a content type, a content to text constructor configured to apply at least one content-to-text construction technique, based on the pre-defined category, to convert the training material into text. The system further comprises a text analyzer configured to parse the text to generate a test script, including a semantic analysis module configured to perform semantic analysis of the text for determining semantics and meaning of phrases of the text. The system further includes a question generator configured to generate a first set of questions based on the semantic analysis of the text, a second set of questions based on the first set of questions; and select a third set of questions from the second set of questions considered most relevant based on topic of training and a specific lesson related to the topic. The system further comprises an answer generator module configured to generate correct answers to the third set of questions based on semantic analysis of the text, and incorrect answers to the third set of questions. The system further includes a testing module configured to present the test script to the user.

In some embodiments, the predefined categories of the content types include at least one of a presentation, a recorded video, a recorded screen, a document or a chat log.

In some embodiments, the content-to-text construction techniques comprises an audio-to-text generator, a text data parser, or an image to text generator.

In some embodiments, the questions are selected based on predefined criteria, and relevance of the questions to the topic is determined based upon a predefined set of rules.

In some embodiments, the one or more training sources comprises a video recording of a lecture, a presentation file containing graphics and text data, a document, a code sample, a chat log, material stored during a lecture session, a PDF file, and a webpage.

In some embodiments, the text analyzer further comprises an answer generator module configured to generate a set of one correct answer and one or more incorrect answers for the user to select at least one answer from the presented answers.

In some embodiments, the method is implemented through a web server, a container, a virtual machine, a plugin, or a preinstalled software.

In some embodiments, the test script is displayed on a display screen operated by the user.

In some embodiments, a first student user and a second student user are associated with a lecture session and the system operations of claim 10 are repeated for the first student user and the second student user. A first test script associated with the first student user includes a unique set of questions different than a second test script associated with the second student user.

In an embodiment, a system for digital lecture session material synthesis comprises a computing device including at least one processor and memory operably coupled to the at least one processor; and instructions that, when executed on the at least one processor, cause the at least one processor to implement: a data classifier configured to classify the digital lecture session material into at least one pre-defined category, a content-to-text constructor configured to convert the digital lecture session material into text based on the at least one pre-defined category, and a text analyzer configured to: parse the text to generate a test script using a semantic analysis model, generate a first set of questions based on the parsing, generate a second set of questions based on the first set of questions, and select a third set of questions from the second set of questions based on a topic of the digital lecture session material, generate one correct answer to each of the third set of questions based on the parsing, and generate a plurality of incorrect answers to the third set of questions.

In one embodiment, the instructions that, when executed on the at least one processor, cause the at least one processor to further implement a testing module configured to present the test script.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a block diagram of a system environment for conducting a student assessment, in accordance with an embodiment.

FIG. 2 is a block diagram of a system for conducting a student assessment, in accordance with an embodiment.

FIG. 3 is a flowchart of a method for conducting active assessment of a user based on training material, in accordance with an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

The present disclosure relates to systems and methods for conducting a student assessment by generating a unique set of questions for each student user based on the training material of the taught subject matter. A lecturer user uploads the training material in different formats in the system, and the system generates the set of questions along with a set of one correct and multiple incorrect answers for each question based on the uploaded training material. The system can analyze if the student has selected a correct option or not and calculate an assessment result (e.g. for each student). With the present disclosure, frequent and flexible testing is possible, which helps students to learn faster and more efficiently as compared to conventional methods.

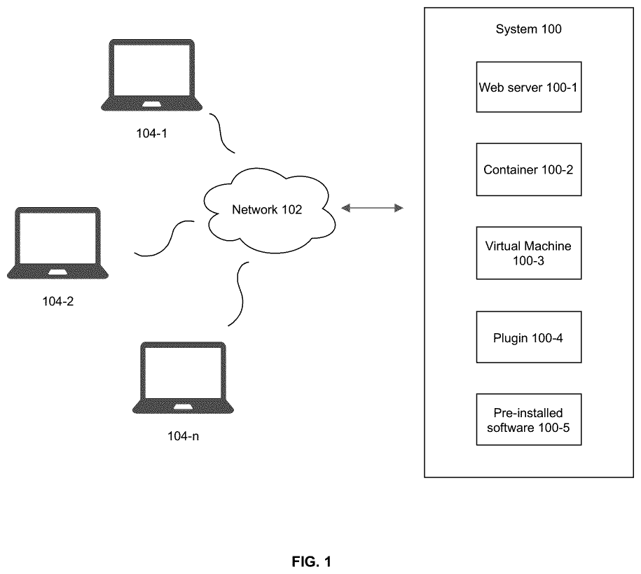

FIG. 1 is a block diagram of a system 100 environment, in accordance with an embodiment. The system 100 is configured to conduct a user assessment based on training material. The system 100 can be implemented as at least one of a web server, a container, a virtual machine, a plugin, or preinstalled software. The system 100 can be implemented through a computing device operated by one or more users. The user may be an individual having access to one or more personal computing devices shown in the Figure as 104-1, 104, 2, 104-n; for example, a smartphone, a laptop, or desktop computer (not shown in the Figures). In an embodiment, the user may have to login, through each personal computing device, into the system 100 using his security credentials.

The user, in one embodiment, can include one or more students taking a specific course, and at least one lecturer teaching the specific course. The system 100 is not limited to one course. A group of students may take multiple courses taught by the same lecturer or different lecturers. The system 100 allows each user to use the respective registered credentials to log in and access the system 100. The user can access the opted courses with varying rights, such as student's rights or the lecturer's rights.

In one embodiment, one or more computing devices are connected to the system 100 through a network 102. The network 102 can be a public network 102 or a private network 102. The network 102 can be a wired network 102 or a wireless network 102. In one embodiment the network 102 can be a cellular network 102.

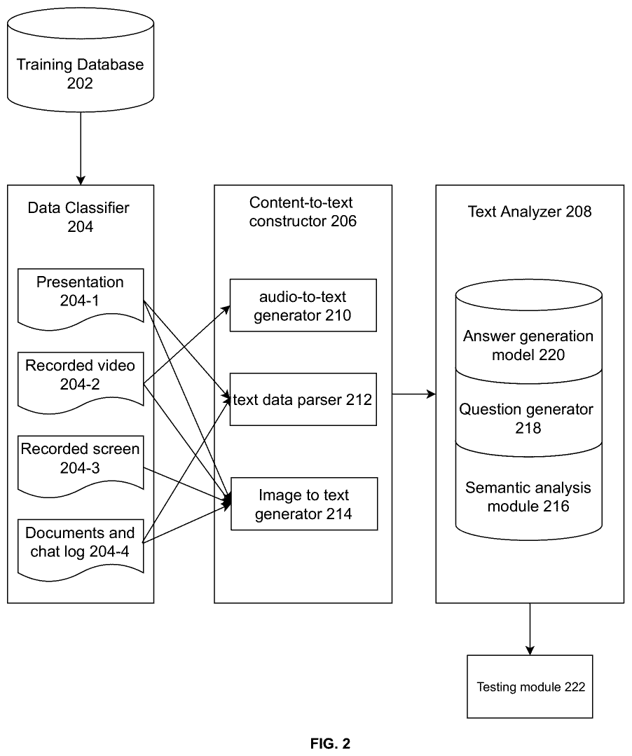

FIG. 2 is a block diagram of the system 100, in accordance with an embodiment. The system 100 includes, but may not be limited to, a training database 202, a data classifier 204, a context-to-text constructor 206, a text analyzer 208, and a testing module 222. Accordingly, the system 100 is implemented on one or more computing devices including at least one processor and operably coupled memory.

System 100 includes various engines (e.g. classifier, constructor, analyzer, module), each of which is constructed, programmed, configured, or otherwise adapted, to autonomously carry out a function or set of functions. The term engine as used herein is defined as a real-world device, component, or arrangement of components implemented using hardware, such as by an application specific integrated circuit (ASIC) or field-programmable gate array (FPGA), for example, or as a combination of hardware and software, such as by a microprocessor system and a set of program instructions that adapt the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each engine can be realized in a variety of physically realizable configurations, and should generally not be limited to any particular implementation exemplified herein, unless such limitations are expressly called out. In addition, an engine can itself be composed of more than one sub-engines, each of which can be regarded as an engine in its own right. Moreover, in the embodiments described herein, each of the various engines corresponds to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

In one embodiment, the training database 202 is configured to obtain the training material from one or more training sources. In one embodiment, the training material is any descriptive or explanatory study material related to a subject matter taught in an e-learning session. In an embodiment, an e-learning session (or “lecture session”) is an instance in which a student user or lecturer user is utilizing the training material via the system 100. In one embodiment, the training sources can be a lecturer's computing device using which a document file, presentation file, recorded video, recorded screen, chat logs, and similar data inputs in other suitable formats are uploaded in the training database 202. In another embodiment, the training material can be obtained from other sources, such as web pages, public databases, private databases, or such similar input sources.

In accordance with one embodiment, the training material collected in the training database 202 is fetched by the data classifier 204. The data classifier 204 is configured to classify the training material into at least one pre-defined category based on the content type. The predefined categories are, but may not be limited to, presentation 204-1, recorded video 204-2, recorded screen 204-3, documents and chat logs 204-4. For example, the lecturer may upload the training material in .doc or .txt format. The data classifier 204 identifies the format, and accordingly, classifies it as the document and chat log category. Likewise, the lecturer may upload a video file with an extension, such as .mkv, .mpg, .avi, .dat, and the like. Such video files may be categorized as the recorded video category. Accordingly, the data classifier 204 can categorize uploaded training material based on extension, metadata, evaluation of the material itself, or other suitable categorization determination.

In accordance with another embodiment, the content to text constructor 206 is configured to apply at least one content-to-text construction technique, based on the pre-defined category of the content type, to convert the training material into text. The content-to-text construction technique is selected in accordance with the category of the training material as classified by the data classifier 204. For one category of the training material, one or more context-to-text construction techniques can be applied.

In one embodiment, for the category of presentation 204-1, a text data parser 212 to an image to text generator 214 can be applied. The presentation, for an example, can be a POWERPOINT presentation and may include text along with images, photos, drawings, charts, and other visual aids. Text from the presentation is parsed using the text data parser 212. Text data parsing is a programming task that separates the given series of text into smaller components based on certain rules. Further, for the visual aids used in the presentation, the image to text generator 214, alternatively referred to as image to text constructor, is applied. The image to text constructor converts an image or such visual representation into text.

In one embodiment, for the category of recorded videos 204-2, an audio to text generator 210 and image to text generator 214 can be applied to convert the recorded video into text. The recorded video file may include video and audio inputs. The audio inputs are converted into text using the audio-to text generator 210, which is a component configured to convert audio inputs into text. The video is converted into text using the image to text converter 214.

In one embodiment, for the category of recorded screens 204-3, the image to text generator 214 is applied to convert the recorded screen into text. In an example, where the screen is recorded with an audio input, the audio to text generator 210 can be applied to convert the audio into text.

In another embodiment, for the category of the documents and chat logs 204-4, the text data parser 212 and the image to text generator 214 is applied to convert the documents and chat logs into text. For example, the documents may include a .doc file including text and charts. To convert the text from the file into text components with applied series of rules, the text data parser 212 is applied to the .doc file. Visual representation from the .doc file is converted into the text using the image to text generator 214.

Once the training material is converted into a specific type of text components, the text is parsed by the text analyzer 208 to generate a test script, in accordance with an embodiment. The text analyzer 208 is a component configured to parse the text constructed by the context to text converter for generating the test script. The test script, in one embodiment, includes at least a set of questions and a set of answers (including correct and wrong answers) for each question.

According to an embodiment, the text analyzer 208 includes, but may not be limited to a semantic analysis module 216, a question generator 218, and an answer generation module 220. The semantic analysis module 216, in one embodiment, is a component configured to perform semantic analysis on the text constructed by the context to text constructor 206. In an embodiment, semantic analysis is the process of drawing meaning from text. It allows computers to understand and interpret sentences, paragraphs, or whole documents, by analyzing their grammatical structure, and identifying relationships between individual words in a particular context to perform semantic analysis of the text for determining semantics and meaning of phrases of the text. As the semantic analysis module interprets and construes the meaning of the text, questions are generated based on the text. Semantic analysis applies to the initial data provided to the system and not on the questions itself. Therefore, techniques used in semantic analysis have no dependencies on question types. Semantic analysis uses machine-learning models and techniques, comprising Large language models (LLM), transformer models, and classification models.

In accordance with an embodiment, the question generator 218 is configured to generate a first set of questions based on the semantic analysis of the text from semantic analysis module 216. The first set may include questions formed on the basis of constructed meaning of the text. In an embodiment, the first set is filtered and amended to generate a second set of questions. The second set includes questions with improved quality, in sense of wording, structure, formation, or meaning, and is a filtered version of the first set to avoid repetitive questions. In one embodiment, the second set is analyzed to select a third set of questions from the second set of questions. Questions from the third set are considered most relevant to the subject matter of training and a specific lesson related to the subject matter. For example, if the subject matter relates to a history lesson covering the Pearl Harbor attack event, the second set of questions may include the questions from the history of World War II. However, by analyzing the second set of questions in view of the subject matter, the third set may include questions particularly pertaining to the Pearl Harbor attack. In a nutshell, the questions are selected based on predefined criteria, and relevance of the questions to the topic is determined based upon a predefined set of rules. The predefined criteria includes criterias of selecting questions by type of the questions, questions containing most frequent words or keywords in terms of semantic analysis, questions or topics of the question that are in blacklist or related to common phrases. The pre-defined set of rules includes, but is not limited to, the rules, such as number of questions, degree of relevance, degree of difficulty level and the like. In one embodiment, a predefined set of rules comprises an assessing generative model to assess the quality of generated questions and provide quality scores.

In accordance with an embodiment, the answer generation module 220 is configured to generate answers for each question for the third set of questions. In one embodiment, the answer generation module 220 is configured to generate at least one correct answer to each question based on a semantic analysis of the text constructed from the training material. Further, one or more incorrect answers are generated for each question to present multiple options for a student to select from. For example, for question A, at least four answers (1, 2, 3, and 4) are generated, among which answer 3 is correct and 1, 2, and 4 answers are incorrect. The student is prompted to select at least one answer from the multiple options presented for question A.

In accordance with an embodiment, the testing module 222 is configured to present the test script, inclusive of the third set of questions and multiple answers to each question, to the user, such as each student logged into the session. The test script is displayed on a display screen operated by the user. In one embodiment, the test is presented sequentially—one by one question. The test script is displayed in a form of question text and input form. The input form can contain multiple lines of text data, one line of text data, field with predefined type of data (symbols, numbers, words, etc.) multiple choice or single choice of answer options.

According to one embodiment, an assessment module (not shown in the Figure) is provided to identify the correct answers selected by each student and generate an assessment report for each student.

In one embodiment, the operations performed by the system 100 are repeated for each student to generate a unique set of questions. Each student may receive different question sets generated based on the similar pre-defined criteria.

In one example, where the lesson materials contain a lecture, describing “the sun”. The text contains the following sentences: “Cool, dark sunspots dot the photosphere, or the sun's surface where the magnetic field is strong, and they can be the size of Earth or larger”; “Clusters of sunspots are the cause of solar flares and coronal mass ejections”; “These energetic outbursts from the sun can impact Earth's satellite-based communications”; “The sunspot regions shown in the images are a study in contrast. Bright hot plasma flows upward on the sun's surface, while darker, cooler plasma flows down. In the chromosphere, the atmospheric layer above the surface, threadlike structures reveal the presence of magnetic fields”; “Another image shows a sunspot that has lost the majority of its brighter, surrounding region, or penumbra, which seems to be decaying. Researchers believe the remaining fragments could be the end point in the evolution of a sunspot, before it disappears.” Based on this text the system generates the following questions of different types:
1. Multiple Choice: What are sunspots? Answer options: a. Bright hot spots on the sun's surface; b. Cool, dark spots on the sun's surface where the magnetic field is strong; c. Regions on the sun's surface where the magnetic field is weak; d. Locations on the sun where solar flares originate. Correct answer: The correct answer is (b) Cool, dark spots on the sun's surface where the magnetic field is strong.
2. True or False: Can the energetic outbursts from the sun impact Earth's satellite-based communications? Correct answer: True
3. Open Response: Describe the contrast observed in the sunspot regions. Possible answer: “The sunspot regions show a contrast with bright hot plasma flowing upward on the Sun's surface and darker, cooler plasma flowing down. Fine, detailed structures, including glowing dots where the magnetic field is the strongest, can be seen in the dark sunspots. Bright strands derived from the magnetic field, called penumbral filaments, which transport heat, surround the sunspot”
4. Short Text: What solar feature could indicate that a sunspot is about to decay? Correct answer: Light bridges.

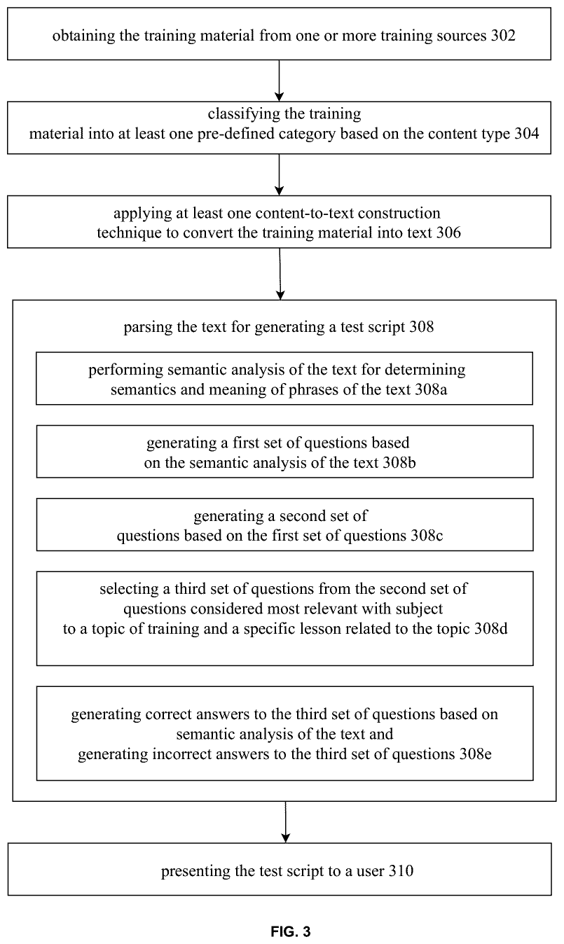

FIG. 3 is a flowchart of a method 300 for conducting active assessment of a user based on training material, in accordance with one embodiment. The method is a computer implemented method.

At 302, the training material is obtained from one or more training sources to store at the training database 202.

At 304, the training material stored at the training database 202 is classified into at least one pre-defined category based on the content type.

At 306, at least one content-to-text construction technique is applied to the training material, based on the pre-defined category of the content type, to convert the training material into text.

At 308, the text constructed by the content to text constructor 206 is parsed by the text analyzer 208 for generating a test script. At 308a, semantic analysis of the text is performed for determining semantics and meaning of phrases of the text. At 308b, a first set of questions is generated based on the semantic analysis of the text. At 308c, the second set of questions is generated based on the first set of questions. At 308d, a third set of questions is selected from the second set of questions considered most relevant to a topic of training and a specific lesson related to the topic. At 308e, a correct answer is generated for each of the third set of questions based on semantic analysis of the text, and one or more incorrect answers are generated for each of the third set of questions.

At 310, the test script is presented to the user.

1. A method for conducting active assessment of a user based on training material comprises:
obtaining the training material from one or more training sources;
classifying the training material into at least one pre-defined category based on a content type;
applying at least one content-to-text construction technique, based on the pre-defined category of the content type, to convert the training material into text;
parsing the text for generating a test script including by:
performing semantic analysis of the text to determine semantics and meaning of phrases of the text;
generating a first set of questions based on the semantic analysis of the text;
generating a second set of questions based on the first set of questions;
selecting a third set of questions from the second set of questions considered most relevant based on a a topic of training and a specific lesson related to the topic, and
generating a test script including one correct answer to the third set of questions and a plurality of incorrect answers to each of the third set of questions based on semantic analysis of the text; and
presenting the test script to a user.

2. The method of claim 1, wherein the pre-defined category of the content type includes at least one of a presentation, a recorded video, a recorded screen, a document, or a chat log.

3. The method of claim 1, wherein the applying at least one content-to-text construction technique comprises applying an audio-to-text generator, applying a text data parser, or applying an image to text generator.

4. The method of claim 1, wherein the questions are selected based on predefined criteria, and relevance of the questions to the topic is determined based upon a pre-defined set of rules.

5. The method of claim 1, wherein the one or more training sources comprises a video recording of a lecture, a presentation file containing graphics and text data, a document, a code sample, a chat log, material stored during a lecture session, a PDF file, and a webpage.

6. The method of claim 1, wherein presenting the test script to the user comprises presenting a set of one correct answer and one or more incorrect answers for the user to select at least one answer from the set of one correct answer and the one or more incorrect answers.

7. The method of claim 1, wherein the method is implemented through a web server, a container, a virtual machine, a plugin, or a preinstalled software.

8. The method of claim 1, wherein the test script is displayed on a display screen operated by the user.

9. The method of claim 1, wherein a first student user and a second student user are associated with a lecture session and the method operations of claim 1 are repeated for the first student user and the second student user, wherein a first test script associated with the first student user includes a unique set of questions different than a second test script associated with the second student user.

10. A system to conduct active assessment of a user based on training material, the system comprising:
a training database configured to store the training material from one or more training sources;
a data classifier configured to classify the training material into at least one pre-defined category based on a content type;
a content to text constructor configured to apply at least one content-to-text construction technique, based on the pre-defined category, to convert the training material into text;
a text analyzer configured to parse the text to generate a test script, including:
a semantic analysis module configured to perform semantic analysis of the text for determining semantics and meaning of phrases of the text,
a question generator configured to:
generate a first set of questions based on the semantic analysis of the text,
generate a second set of questions based on the first set of questions, and
select a third set of questions from the second set of questions considered most relevant based on topic of training and a specific lesson related to the topic, and
an answer generator module configured to generate:
one correct answer to each of the third set of questions based on semantic analysis of the text, and
a plurality of incorrect answers to the third set of questions; and
a testing module configured to present the test script to the user.

11. The system of claim 10, wherein the predefined categories of the content types include at least one of a presentation, a recorded video, a recorded screen, a document, or a chat log.

12. The system of claim 10, wherein the content-to-text construction techniques comprises an audio-to-text generator, a text data parser, or an image to text generator.

13. The system of claim 10, wherein the questions are selected based on predefined criteria, and relevance of the questions to the topic is determined based upon a pre-defined set of rules.

14. The system of claim 10, wherein the one or more training sources comprises a video recording of a lecture, a presentation file containing graphics and text data, a document, a code sample, a chat log, material stored during a lecture session, a PDF file, and a webpage.

15. The system of claim 10, wherein the text analyzer further comprises an answer generator module configured to generate a set of one correct answer and one or more incorrect answers for the user to select at least one answer from the presented answers.

16. The system of claim 10, wherein the method is implemented through a web server, a container, a virtual machine, a plugin, or a preinstalled software.

17. The system of claim 10, wherein the test script is displayed on a display screen operated by the user.

18. The system of claim 10, wherein a first student user and a second student user are associated with a lecture session and the system operations of claim 10 are repeated for first student user and the second student user, wherein a first test script associated with the first student user includes a unique set of questions different than a second test script associated with the second student user.

19. A system for digital lecture session material synthesis, the system comprising:
a computing device including at least one processor and memory operably coupled to the at least one processor; and
instructions that, when executed on the at least one processor, cause the at least one processor to implement:
a data classifier configured to classify the digital lecture session material into at least one pre-defined category,
a content-to-text constructor configured to convert the digital lecture session material into text based on the at least one pre-defined category, and
a text analyzer configured to:
parse the text to generate a test script using a semantic analysis model,
generate a first set of questions based on the parsing,
generate a second set of questions based on the first set of questions, and
select a third set of questions from the second set of questions based on a topic of the digital lecture session material,
generate one correct answer to each of the third set of questions based on the parsing, and
generate a plurality of incorrect answers to the third set of questions.

20. The system of claim 19, wherein the instructions that, when executed on the at least one processor, cause the at least one processor to further implement a testing module configured to present the test script.
